(19) United States
(12) Patent Application Publication
(10) Pub. No.: US 2010/0202934 A1
(43) Pub. Date: Aug. 12, 2010

(54) EXHAUST GAS PURIFICATION DEVICE FOR AN EXHAUST SYSTEM

(76) Inventors: Wolfgang Hahnl, Grimma (DE); Marek Birke, Augsburg (DE)

Correspondence Address: PAMELA A. KACHUR, 577 W Santee Drive, Greensburg, IN, 47240, US

(21) Appl. No.: 12/597,514

(22) PCT Filed: Apr. 24, 2008
(86) PCT No.: PCT/EP08/03307

§ 371 Date: Feb. 26, 2010

(30) Foreign Application Priority Data
Apr. 27, 2007 (DE) 10 2007 020 003.1

(51) Int. Cl. F01N 3/021; B01D 53/86; B01D 46/00; B01D 46/10

(52) U.S. Cl. 422/177; 55/482; 55/486

(57) ABSTRACT

An exhaust gas purification device for an exhaust system has a housing that includes an inlet and an outlet, and a gas-permeable substrate. The gas-permeable substrate comprises a hollow body and is arranged in a flow path from the inlet to the outlet. The hollow body is composed of a plurality of flat substrate plates.

### RELATED APPLICATION

This application is the U.S. national phase of PCT/EP2008/003307, filed Apr. 24, 2008, which claimed priority to DE 10 2007 020 003.1, filed Apr. 27, 2007.

### BACKGROUND OF THE INVENTION

The present invention relates to an exhaust gas purification device for an exhaust system.

An exhaust gas purification device within the meaning of the invention is understood to mean, for example, a particulate filter, an oxidation catalytic converter or a NOₓ storage catalytic converter. Such an exhaust gas purification device usually contains a gas-permeable substrate through which the exhaust gas flows to purify the exhaust gas. In the case of a particulate filter, soot particles contained in the exhaust gas, for example, are filtered out of the exhaust gas when it flows through the substrate. Materials used for the substrates are usually brittle and have a low bending strength.

The invention provides an exhaust gas purification device which distinguishes itself by a simple manufacture even when brittle substrate materials are used, and in which, in addition, the substrate heats up quickly in operation to attain the temperature required for an effective operation or else for a regeneration of the exhaust gas purification device.

### SUMMARY OF THE INVENTION

To this end, according to the invention, provision is made for an exhaust gas purification device for an exhaust system that includes a housing with an inlet and an outlet, and a gas-permeable substrate. The gas-permeable substrate is in the form of a hollow body and is arranged in the flow path from the inlet to the outlet. The hollow body is composed of a plurality of flat substrate plates. In particular, an interior of the hollow body is in fluid communication with the inlet, so that the flow path of the exhaust gas leads from the inlet through the substrate and then to the outlet. As a result, after entering the housing of the exhaust gas purification device, the exhaust gas stream at first comes into contact with the substrate and only subsequently with the housing. In this way, the substrate which, as a hollow body, has a comparatively low thermal mass, is heated up first before the housing can draw a relatively large amount of heat from the exhaust gas stream. Since the hollow body is composed of a plurality of flat, planar substrate plates, the hollow body can be produced in a simple manner even from a brittle material and can be securely held in the housing. It is not required to bend the substrate material, for which reason no excessive bending stresses will occur, either during production or in operation in the exhaust system.

According to an embodiment of the invention, arranged inside the substrate is a second substrate which likewise is a hollow body composed of a plurality of flat substrate plates. In this way, a second flow path out of the interior of the first substrate through the second substrate into the interior thereof, and from there to the outlet is provided. The configuration with two substrates offers the advantage of an increased surface accompanied by a low pressure loss.

In one example, the hollow body has a shape which corresponds to a lateral area of a truncated pyramid. When two hollow bodies are used which are arranged one inside the other, they are more particularly placed into each other in opposite directions. Alternatively, the hollow body may, of course, also be in the form of a hollow cylinder, i.e. with a plate distance that is constant over its entire length.

It has been found that production is especially simple if the truncated pyramid has a rectangular, in particular square, or a hexagonal base.

When the hollow body is in the shape of a truncated pyramid, the substrate plates are more particularly trapezoidal; in the case of two substrates, the substrate plates of the inner hollow body are made to be smaller than those of the outer hollow body.

For attachment to each other and in the housing, the substrate plates are preferably held by a frame structure.

The frame structure may include a plurality of fastening members for the substrate plates, which may be, e.g., clips, nails or rivets, which hold the substrate plates to the frame structure.

Alternatively or additionally, the frame structure may be made up of profiles which are U-shaped in cross-section and in which the substrate plates are held directly.

As already mentioned, in most cases brittle materials are used for the substrates. In particular, the substrate plates include at least one of the following materials: metal foam, metallic sponge structure, metal fibers, metallic sintered hollow spheres, wire mesh, knitted wire, expanded metal, ceramic fibers, and ceramic foam. All of these materials distinguish themselves by having a high porosity.

In addition, the substrate plates may be provided with a catalytically active coating.

According to an embodiment, one holder each is provided for the upstream end and for the downstream end of the substrate, the holder being essentially configured as a flat bottom or disk with at least one passage opening. Thus, the substrate may be simply and securely mounted in the housing.

In a further development of the invention, the hollow body includes a plurality of substrate plates stacked on top of each other and made of different materials. By a methodical coordination of the materials used with regard to their different specific purifying and filtering properties, a particularly good purification effect can be achieved.

As already mentioned, the exhaust gas purification device may be a particulate filter, a particulate receiving accumulator, an oxidation catalytic converter or a NOₓ storage catalytic converter. Any desired combinations of these components are, of course, also possible; for example, a particulate filter with an integrated oxidation catalytic converter is conceivable.

These and other features of the present invention can be best understood from the following specification and drawings, the following of which is a brief description.

### BRIEF DESCRIPTION OF THE DRAWINGS

Further features and advantages of the invention will be apparent from the following description of several embodiments with reference to the accompanying drawings, in which:

FIG. 1 shows a longitudinal section through an exhaust gas purification device according to a first embodiment of the invention;

FIG. 2 shows a view of a substrate plate used in the exhaust gas purification device of FIG. 1;

FIG. 3 shows a view of a frame member used in the exhaust gas purification device of FIG. 1;

FIG. 4 shows a section along the line IV-IV in FIG. 3, but with the substrate plate inserted;

FIG. 5 shows a schematic perspective view of the frame structure of the exhaust gas purification device of FIG. 1;

FIG. 6 shows a view of a frame member according to an alternative configuration;

FIG. 7 shows a section along the line VII-VII in FIG. 6, but with the substrate plate inserted;

FIG. 8 shows a sectional view similar to FIG. 7, but for an alternatively configured substrate;

FIG. 9 shows a schematic perspective view of a frame structure with holders for an exhaust gas purification device according to a second embodiment of the invention;

FIG. 10 shows a sectional view of a part of the frame structure from FIG. 9; and

FIG. 11 shows a sectional view of a frame structure that has been slightly modified as compared with FIG. 10.

### DETAILED DESCRIPTION OF THE EMBODIMENT

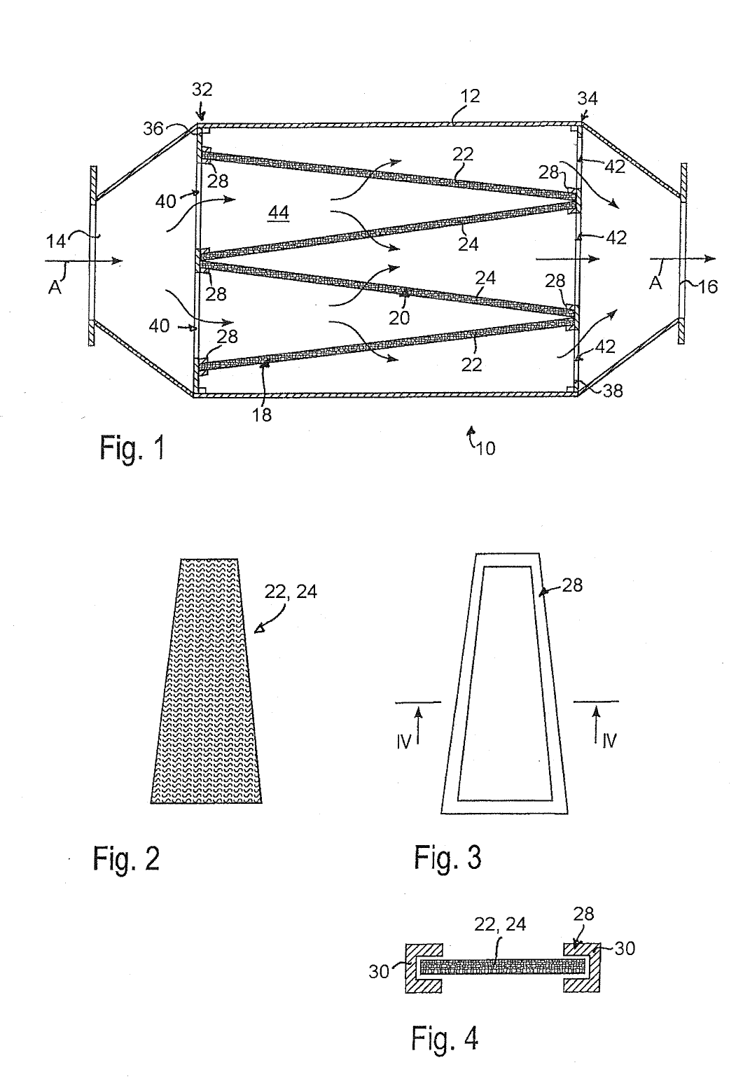

FIG. 1 shows an exhaust gas purification device 10 according to a first embodiment of the invention, which may be a particulate filter, a particulate receiving accumulator, an oxidation catalytic converter, a NOₓ storage catalytic converter or any combination of the above. The exhaust gas purification device 10 is more particularly employed in the exhaust system of a motor vehicle and includes a housing 12 which has an inlet 14 and an outlet 16. A gas-permeable first substrate, 18 which is in the form of a hollow body, is arranged inside the housing 12. A second substrate 20, which is likewise in the form of a hollow body, is arranged inside the first substrate 18. Both substrates 18, 20, i.e. both hollow bodies, have a shape that corresponds to the lateral area of a truncated pyramid having a rectangular, in particular square, base. Both substrates 18, 20 are composed of a plurality of flat substrate plates 22 and 24, respectively, in this case four each. The substrate plates 22, 24 are each trapezoidal (see FIG. 2), with the substrate plates 24 forming the inner, second substrate 20 being smaller than the substrate plates 22 forming the outer, first substrate 18.

For the substrate plates 22, 24, numerous materials come into consideration. The use of metal foam or a metallic “sponge structure” having open pores, metal fibers, metallic hollow spheres, wire mesh, knitted wire, expanded metal, ceramic fibers, or ceramic foam or a ceramic “sponge structure” is conceivable. In addition, the substrate plates 22, 24 may include a catalytically active coating.

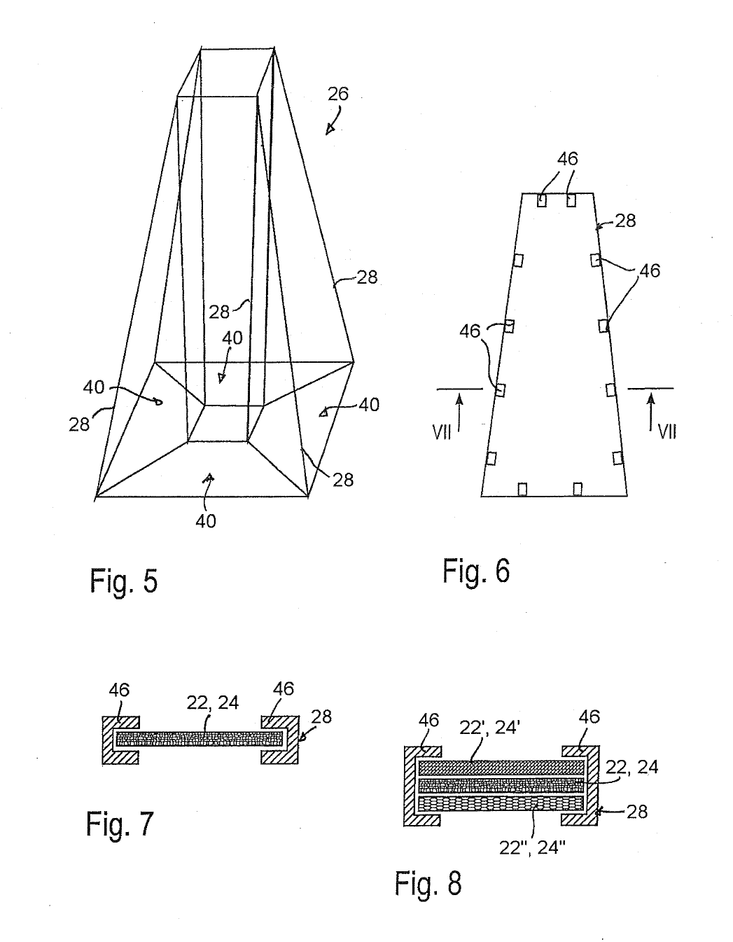

The substrate plates 22 and/or 24 are held by a frame structure 26, which is shown schematically in a slightly modified form in FIG. 5, and includes a plurality of likewise trapezoidal frame members 28 that are connected with each other (see FIG. 3). As is apparent from FIG. 4, the frame structure 26 or the individual frame members 28 are made up of profiles 30 which are U-shaped in cross-section.

Both at the upstream end 32 and at the downstream end 34 of the substrates 18, 20, provision is made for a respective holder 36 and 38, which carries the frame structure 26 and, hence, the substrates 18, 20. Each of the two holders 36 and 38 is essentially in the form of a disk having passage openings, with the entry openings of the first holder 36 being denoted by 40, and the exit openings of the second holder 38 being denoted by 42.

The exhaust gas reaching the exhaust gas purification device 10 flows through the entry openings 40 into a ring-type intermediate space 44, which is formed inside the first substrate 18, but outside the second substrate 20. From this intermediate space 44, which tapers in the direction of the flow path A of the exhaust gas, the exhaust gas can either flow to the outside, that is, through the first substrate 18, or to the inside, in this case through the second substrate 20, and subsequently reaches the outlet 16 through the exit openings 42. In this way, the exhaust gas stream comes into contact with the comparatively cold housing 12 only after it has flowed through the first substrate 18. The portion of the exhaust gas stream flowing through the second substrate 20 does not come into contact with the housing 12 at all. The substrates 18, 20 are able to heat up very quickly due to their comparatively low thermal mass, whereas the housing 12 warms up comparatively slowly, for one thing due to its thermal mass and, for another thing, due to the inevitable cooling by the ambient air. Therefore, in particular after a cold start, the generated exhaust gas can heat up the substrates 18, 20 comparatively quickly since the exhaust gas comes into contact with the substrates almost uncooled. As a result, in a particulate filter, for example, the temperature that is necessary for the regeneration of the substrates 18, 20 is reached very quickly.

FIGS. 6 and 7 show an alternative configuration of the frame structure 26 or frame members 28 which include a plurality of fastening elements in the form of clips 46. The clips 46 hold the substrate plates 22 and/or 24, and are likewise of a U-shaped design in cross-section.

As shown in FIG. 8, each of the substrates 18, 20 or the respective hollow body may include a plurality of substrate plates 22, 22′, 22″ and 24, 24′, 24″, respectively, stacked on top of each other and made of different materials. In a combination of a particulate filter and an oxidation catalytic converter, metal fibers may be employed, for example, as filter material, and metal foam or metallic hollow spheres having a catalytically active coating may be used for the material of the oxidation catalytic converter. The oxidation catalytic converter material is then arranged upstream of the filter material, as viewed in the direction of flow of the exhaust gas, that is, in the case of the first substrate 18 on the inside and in the case of the second substrate 20 on the outside of the hollow body.

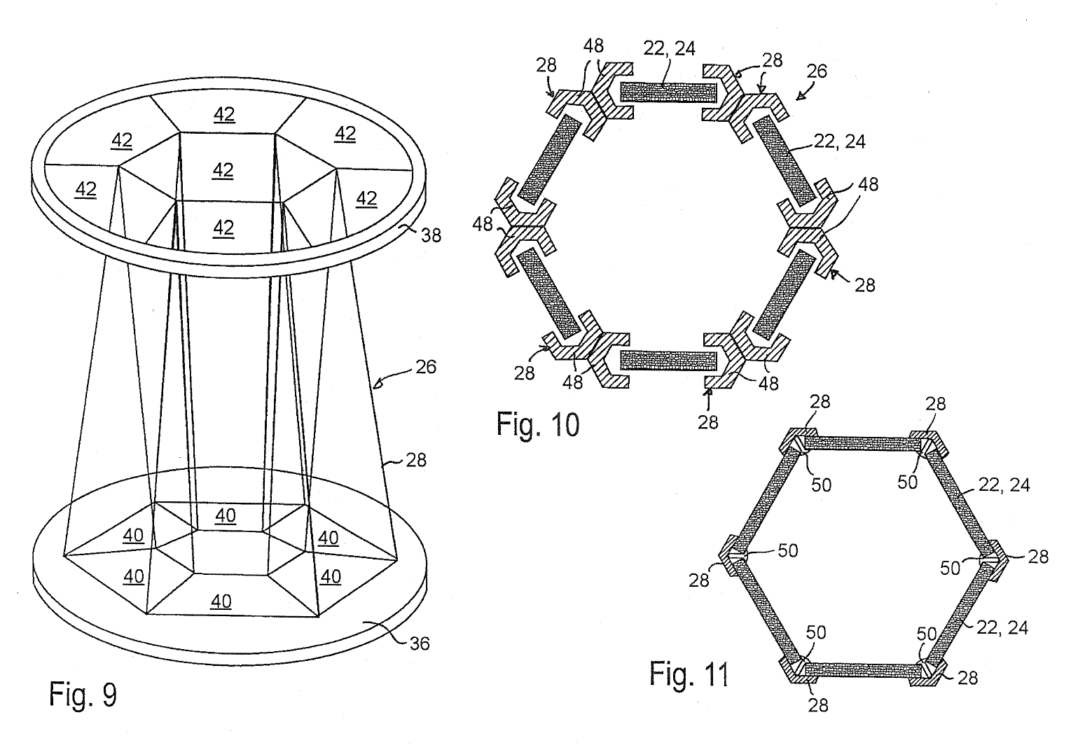

FIG. 9 shows a frame structure 26 as is employed in alternatively designed substrates 18 and 20, which have the shape of the lateral area of a truncated pyramid having a hexagonal base. Also, in this case, the individual substrate plates 22, 24 (six of which form a respective hollow body) are trapezoidal and the substrates 18, 20 or the frame structure 26 are held in the housing 12 by the holders 36, 38.

FIGS. 10 and 11 show two different designs for corresponding frame structures 26. In the configuration according to FIG. 10, the frame members 28 are formed by profiles 48, which in cross-section constitute half a hexagon. According to FIG. 11, on the other hand, provision is made for the substrate plates 22, 24 to be fixed to the angled frame members 28 by fastening elements in the form of nails or rivets 50.

In addition, it is left to the discretion of a person of ordinary skill in the art to employ all of the features described, both individually and in combination with each other, to achieve the object according to the invention.

Although an embodiment of this invention has been disclosed, a worker of ordinary skill in this art would recognize that certain modifications would come within the scope of this invention. For that reason, the following claims should be studied to determine the true scope and content of this invention.

1. An exhaust gas purification device for an exhaust system, comprising:
a housing including an inlet and an outlet; and
a gas-permeable substrate comprising a hollow body, the gas-permeable substrate being arranged in a flow path from the inlet to the outlet, the hollow body being composed of a plurality of flat substrate plates.

2. The exhaust gas purification device according to claim 1, wherein the gas-permeable substrate comprises a first substrate, a second substrate comprising a hollow body composed of a plurality of flat substrate plates, the second substrate being arranged inside the first substrate.

3. The exhaust gas purification device according to claim 1, wherein the hollow body has a shape which corresponds to a lateral area of a truncated pyramid.

4. The exhaust gas purification device according to claim 3, wherein the truncated pyramid has one of a rectangular, or a hexagonal base.

5. The exhaust gas purification device according to claim 1, wherein the plurality of flat substrate plates are trapezoidal.

6. The exhaust gas purification device according to claim 1, wherein the plurality of flat substrate plates are held by a frame structure.

7. The exhaust gas purification device according to claim 6, wherein the frame structure includes a plurality of fastening members for the plurality of flat substrate plates.

8. The exhaust gas purification device according to claim 6, wherein the frame structure is made up of profiles which are U-shaped in cross-section.

9. The exhaust gas purification device according to claim 1, wherein the plurality of flat substrate plates include at least one of the following materials: metal foam, metallic sponge structure, metal fibers, metallic hollow spheres, wire mesh, knitted wire, expanded metal, ceramic fibers, and ceramic foam.

10. The exhaust gas purification device according to claim 1, wherein the plurality of flat substrate plates include a catalytically active coating.

11. The exhaust gas purification device according to claim 1, wherein one holder each is provided for an upstream end and for a downstream end of the gas-permeable substrate, the holder being configured as a disk with at least one passage opening.

12. The exhaust gas purification device according to claim 1, wherein the plurality of flat substrate plates are stacked on top of each other and are made of different materials.

13. The exhaust gas purification device according to claim 1, wherein the exhaust gas purification device comprises at least one of a particulate filter, a particulate receiving accumulator, an oxidation catalytic converter, or a NOₓ storage catalytic converter.
